(19) United States
(12) Patent Application Publication
(10) Pub. No.: US 2014/0075300 A1
(43) Pub. Date: Mar. 13, 2014

(54) RECIPIENT BASED CUSTOMIZATION CARD GROUPS

(71) Applicant: Apple Inc., Cupertino, CA (US)

(72) Inventors: Eric B. HANSON, Emeryville, CA (US); Rachel A. ROTH, San Francisco, CA (US); Andre SOUZA DOS SANTOS, Santa Clara, CA (US)

(21) Appl. No.: 13/906,167

(22) Filed: May 30, 2013

Related U.S. Application Data
(60) Provisional application No. 61/699,846, filed on Sep. 11, 2012.

(51) Int. Cl. G06F 17/27

(52) U.S. Cl. CPC G06F 17/27
USPC 715/255

(57) ABSTRACT

A method for creating and sending customized cards to members on a list can include steps for designing a first card, creating a member list and dividing the member list into at least two groups. The first card can initially be associated with all members included in the member list. A second card can be designed and can be based, at least in part, on the first card. The second card can be associated with at least one member group. A data file can be created that can include the first and second card designs and association information regarding the card designs and the member groups.

### CROSS-REFERENCE TO RELATED APPLICATIONS

This application claims the benefit under 35 U.S.C. 119(e) of U.S. Provisional Patent Application No. 61/699,846, filed Sep. 11, 2012 and entitled “RECIPIENT BASED CUSTOMIZATION CARD GROUPS” by Eric HANSON, which is incorporated herein by reference in its entirety for all purposes.

### FIELD OF THE DESCRIBED EMBODIMENTS

The described embodiments relate generally to photo card design and more particularly to designing and customizing cards for individual members or groups of members.

### BACKGROUND

Cards, such as greeting cards are often sent by people to mark events, or send their seasonal salutations. Cards can also used for invitations (birthday, anniversary or for announcements (birth announcements, etc.) Many times, cards are simply purchased in bulk, from card providers that can make thousands of the same cards. Such cards may not be personalized sufficiently for some card senders. Even if a customized card could be found, often the customized card may not be the best design for all possible recipients for a particular user (sender). Many times, the user can desire that different versions of a card be available for different recipients. Such a card design task can be difficult and managing the recipient list can be burdensome.

Therefore, what is desired is a way to design customized cards and manage the association of the customized cards with different recipients.

### SUMMARY OF THE DESCRIBED EMBODIMENTS

This paper describes various embodiments that relate to card design and member list management.

A method for creating and sending customized cards to members on a list can include steps for designing a first card, creating a member list and dividing the member list into at least two groups. The first card can initially be associated with all members included in the member list. A second card can be designed and can be based, at least in part, on the first card. The second card can be associated with at least one member group. A data file can be created that can include the first and second card designs and association information regarding the card designs and the member groups.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a diagram of a user interface showing a card selection screen, according to some embodiments.

FIG. 2 is a diagram of a user interface showing another embodiment of a card selection screen, according to some embodiments.

FIG. 3 is a diagram of a user interface showing one embodiment of a card customization screen, according to some embodiments.

FIG. 4 is a diagram of a user interface showing one embodiment of a member entry and list management screen, according to some embodiments.

FIG. 5 is a diagram of a user interface showing another embodiment of a card customization screen, according to some embodiments.

FIG. 6 is a diagram of a user interface showing a card project screen, according to some embodiments.

FIG. 7 is a diagram of a user interface showing a card project screen organized by recipient, according to some embodiments.

FIG. 8 is a block diagram illustrating layers in a card project, according to some embodiments.

FIG. 9 is a diagram of an electronic device used to create a printer ready document for distribution in a member list, according to embodiments disclosed herein.

FIG. 10 is a flow chart of steps in a method for creating and sending cards to list members, according to some embodiments.

In the figures, elements referred to with the same or similar reference numerals include the same or similar structure, use, or procedure, as described in the first instance of occurrence of the reference numeral.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

One embodiment for creating cards and managing an association of the created cards to card recipients can include a user application executed on a computing device. The computing device can be any technically feasible device, typically including a processor, a display, an input component, an output component and volatile and non-volatile storage. By way of example and not limitation, a computing device can include a desktop computer, a laptop computer, a tablet computer and a cell phone, a portable media player or any other handheld electronic device.

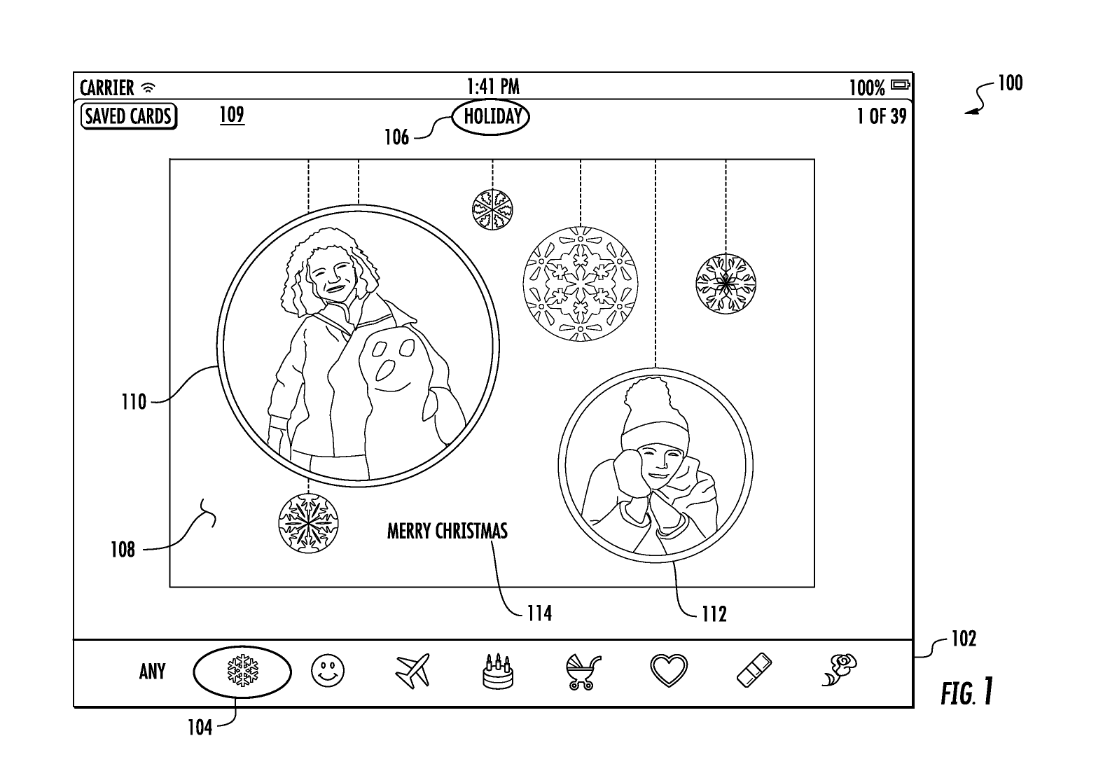

FIG. 1 is a diagram of a user interface showing a card selection screen 100. The user interface can be displayed on a display component of a computing device. A variety of cards may be selectable from this screen. In one embodiment, some cards can be grouped together as cards having a common theme. Some examples of themes can be holiday, travel, birthday, get well, and other messages. A theme selection area 102 can appear within the card selection screen 100. In one embodiment, the theme groups can be represented with icons in the theme selection area 102. In this example, a holiday theme is selected. The theme selection can be indicated by a highlighted icon 104 in the theme selection area 102 and also a theme indicator 106 that can be shown in a menu bar 109 of the card selection screen 100.

A card can be selected from a number of available card templates. A cursor can be used to select different card templates. In this example, a Christmas card template 108 is shown within the card selection screen 100. The card template 108 can include picture regions for the user to insert pictures into the card design. In this example, the user can select a picture for display in a first picture region 110 and a second picture region 112. Other card templates can include different numbers of picture regions. A card template can also include a default caption displayed in a caption region 114.

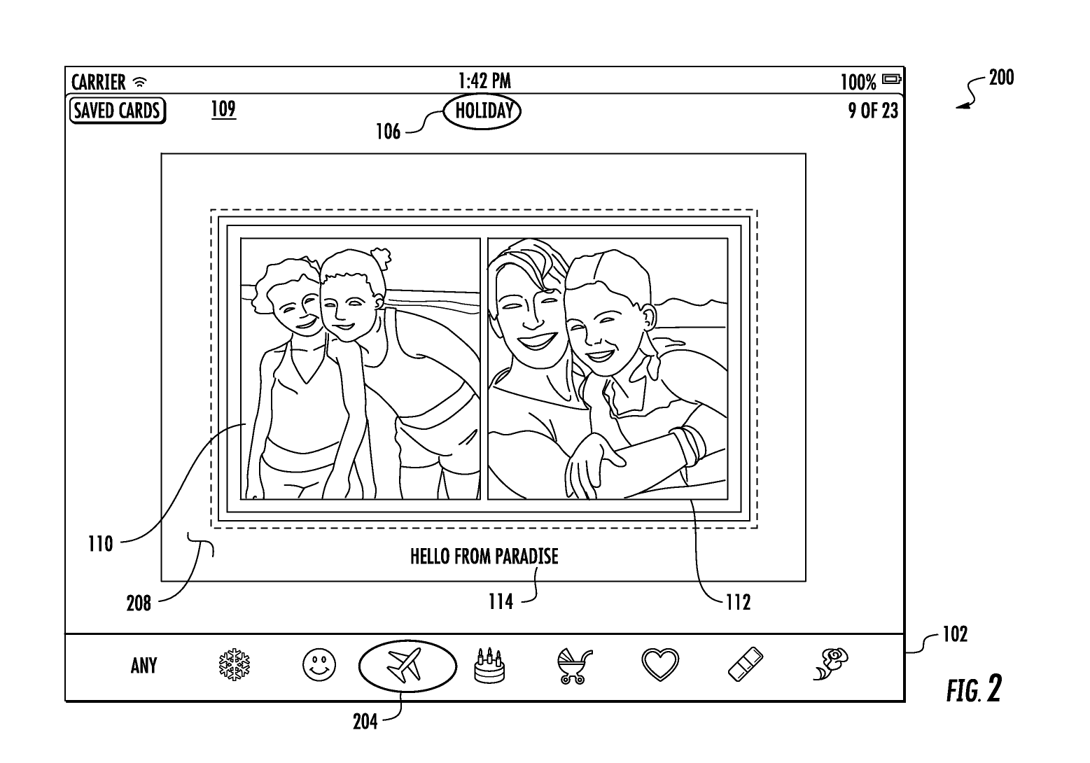

FIG. 2 is a diagram of a user interface showing another embodiment of a card selection screen 200. This embodiment shows another possible template having common elements with the card template 108 from FIG. 1. The theme selection area 102 can show a highlighted travel related icon 204. Also, the theme indicator 106 in the menu bar can display the name of the selected theme. A travel themed card template 208 is shown with a first picture region 110 and a second picture region 112. Other cards can have different numbers of picture regions. Caption region 114 can include a default caption associated with card template 208. Menu bar 109 is as described above (cf. FIG. 1).

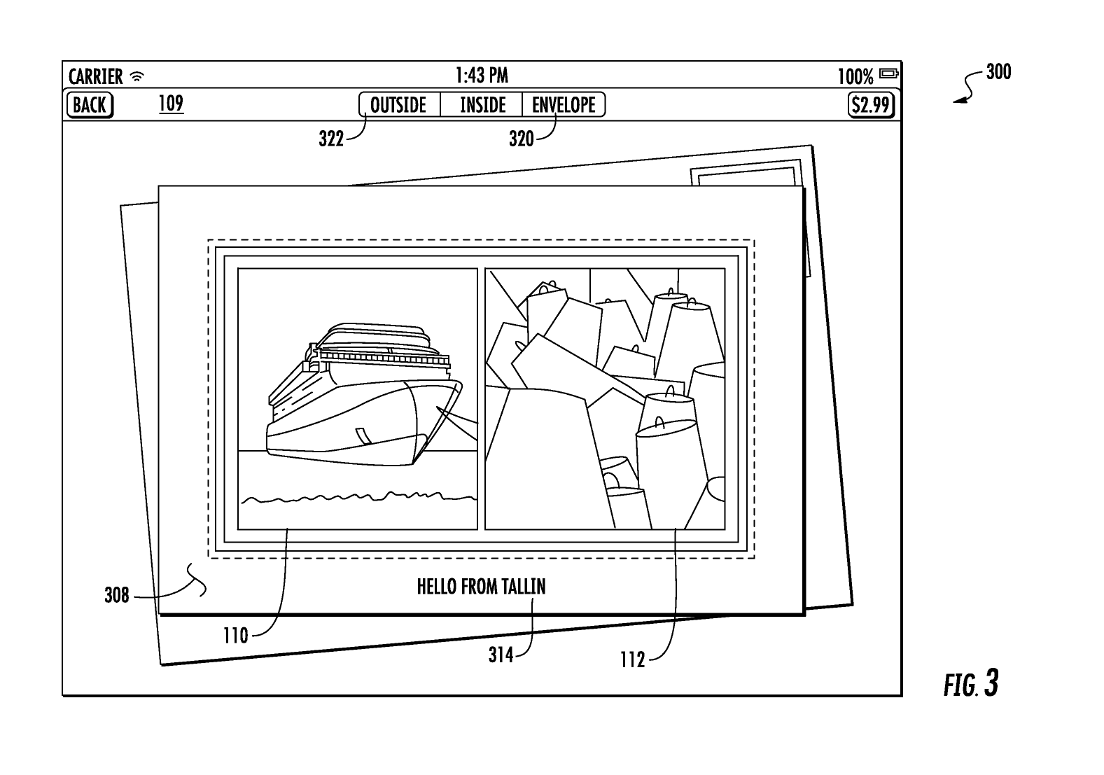

FIG. 3 is a diagram of a user interface showing one embodiment of a card customization screen 300. Card customization screen 300 may be selected from menu bar 109. After the user selects a card template from a selected theme (FIG. 1 or 2, for example), the selected card template 308 can be shown in the card customization screen 300. The selected card template 308 can include a first picture region 110 and a second picture region 112. In one embodiment, pictures can be selected and inserted into the first picture region 110 or the second picture region 112. Photos can be selected from images stored on the computing device, images stored in a remote server or photos can be captured with a camera included with the computing device. For example, in some embodiments the computing device may include a cell phone or any other handheld electronic device having a camera. In one embodiment, the caption 314 can be customized by the user. A display attribute button bar 320 can allow the user to display different attributes associated with the selected card template 308. In one embodiment, the user can select to view the outside or the inside of the selected card template 308 as well as an envelope. In this example, the outside button 322 has been selected, thus the outside of the selected card template 308 is shown. Thus, the outside portion and the inside portion of a card may be edited through the user interface using customization screen 300. The outside portion of a card may include a picture and a caption (e.g., picture 110, caption 114) in a template 308. The inside portion of a card may include a message, such as a text message, with a personal signature identifying the user (or sender). In some embodiments the inside portion of the card may include images, pictures, diagrams, or any other message that the user desires to convey. For example, in some embodiments the inside portion of a card may include a map, such as a street map, with driving directions to get to a certain place, at a certain time, to attend an event.

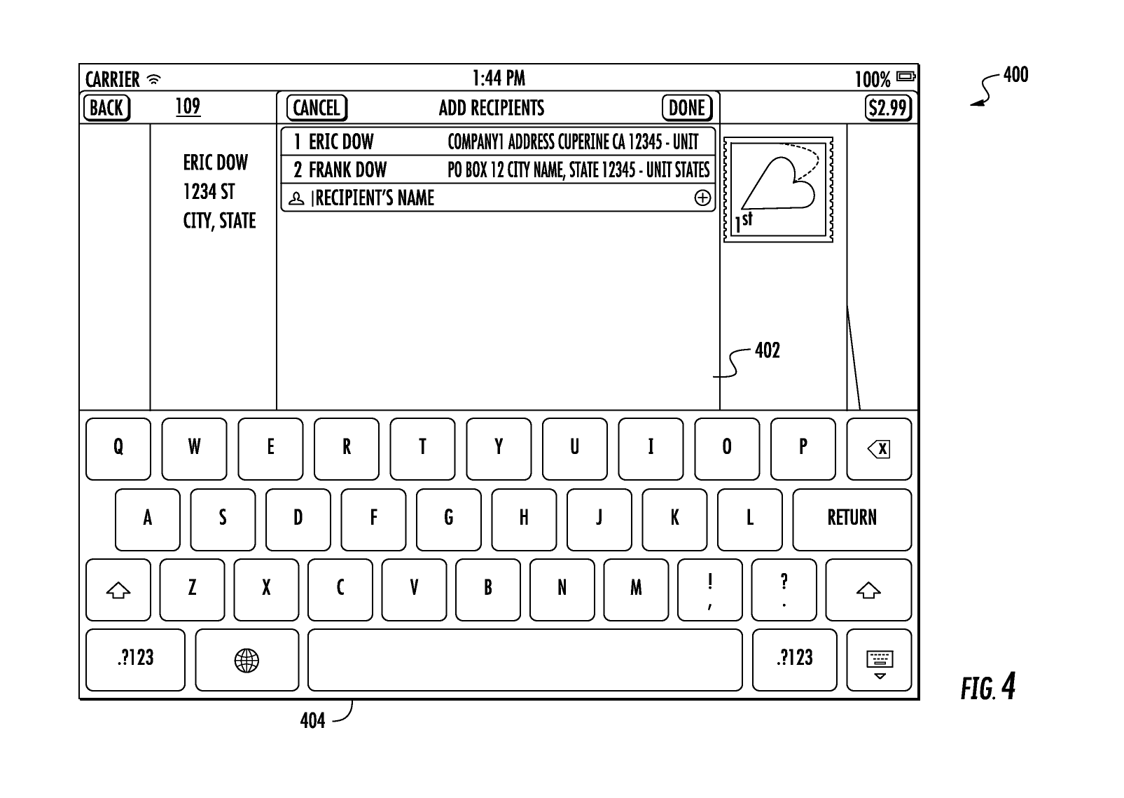

FIG. 4 is a diagram of a user interface showing one embodiment of a member entry and list management screen 400. List management screen 400 may be selected from menu bar 109. Members of a member list (mailing list) can be entered and managed though the member entry and list management screen 400. Members and related member attributes can be entered and can form a member list. In one embodiment, member information can be entered in member entry area 402. In one embodiment, an on-screen keyboard 404 can be used to enter member information. Member list information can include member name and member addresses. The member list can be divided into two or more member groups. The member groups can be arbitrary, or can be selected to divide the member list into logical groups. For example, a member list can be divided into a ‘friends’ group, a ‘family’ group, and a ‘co-workers’ group. The number and nature of the logical groups is not limiting, as one of ordinary skill may recognize. Other embodiments may divide the member list into more groups.

Returning to FIG. 3, the initial selected template 308, along with the initial selected pictures in the first picture region 310 and the second picture region 312 and the initial caption 314 can be associated with each member in the member list. The cards that are associated with each member can be individually customized. In one embodiment, the user can change or modify any element of a card associated with a member. Thus, although the card was initially based on a common design (card template 308, for example), the card associated with each member in the member list may differ from any other users card. The user need only make changes to the card associated with a selected user. In another embodiment, a selected card template (with related edits and customizations) can be associated with a group of members, instead of only an individual member. In this way a common card design can be associated with a member group list. Card designs can be advantageously associated with a group allowing changes to be managed in a group centric fashion instead of individually.

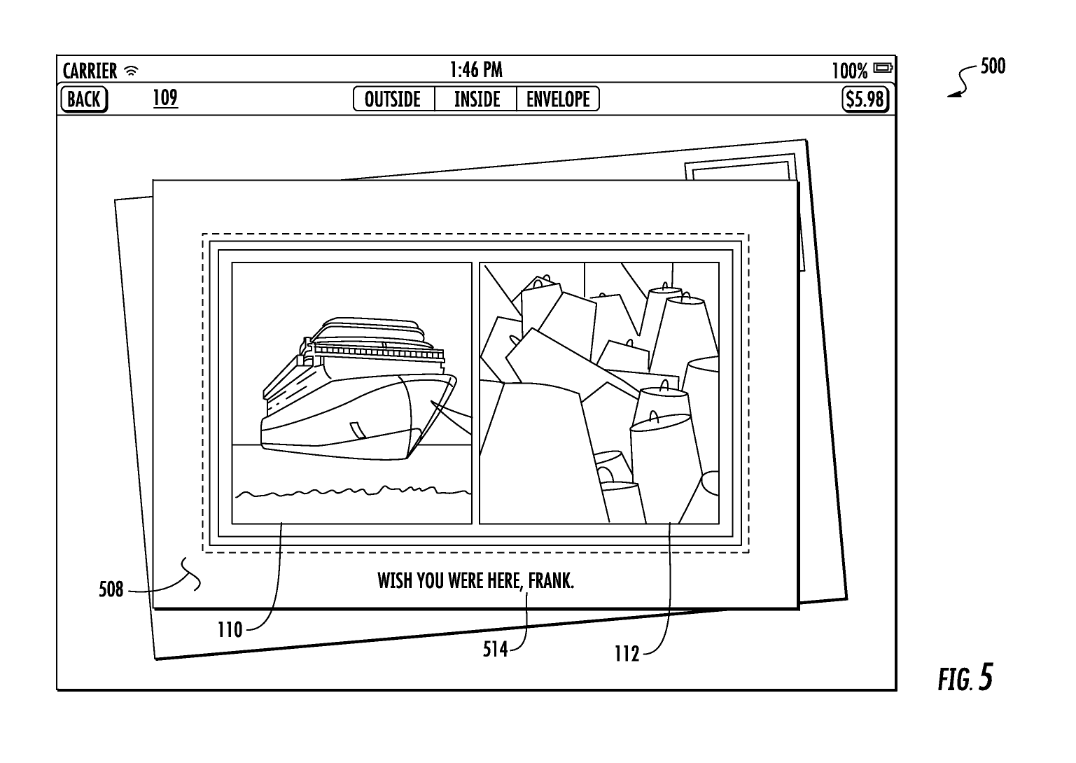

FIG. 5 is a diagram of a user interface showing another embodiment of a card customization screen 500. Card customization screen 500 may be selected from menu bar 109. Card template 508 can be based on card template 308 selected earlier, however, card template 508 can be customized and then associated with one or more members in the member list or can be associated with a group formed from the member list. In this example, the first picture region 110 and the second picture region 112 can include the same photos from card template 308. In this example, caption 514 can be customized for an individual member included in the member list. In another embodiment, any element of card template 308 can be changed or edited and the resulting card template can be associated with a group of members (member groups as defined in FIG. 4 above).

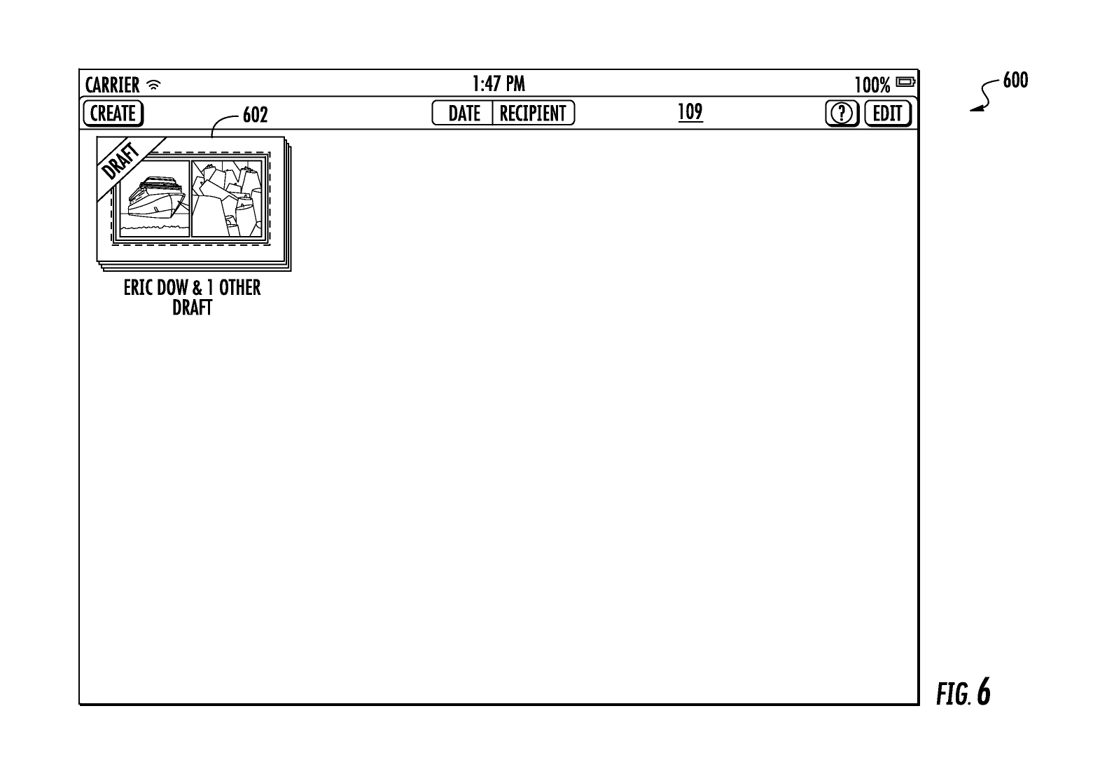

FIG. 6 is a diagram of a user interface showing a card project screen 600. Card project screen 600 may be selected from menu bar 109. In one embodiment, a high level image showing a card template 602 can be shown and can represent all cards associated with a particular member list. However, if one or more cards has been edited or modified for an individual member, or a group of members, card project screen 600 may not make the changes evident.

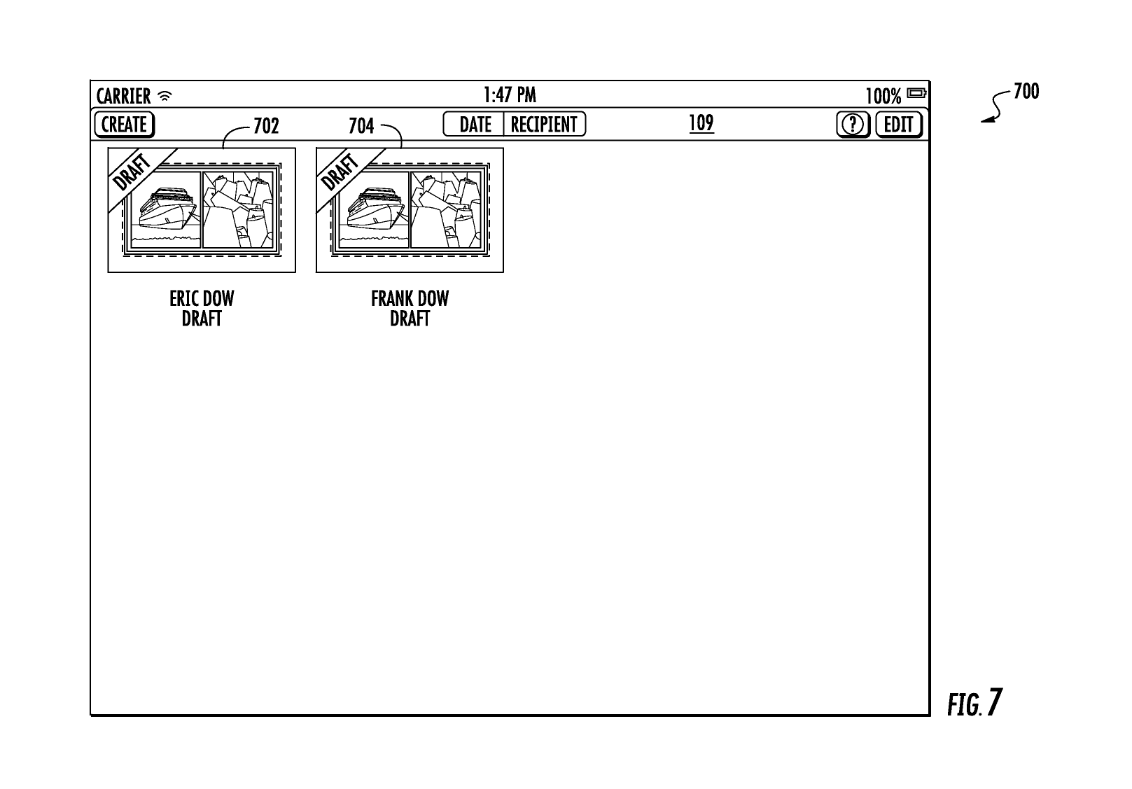

FIG. 7 is a diagram of another embodiment of a user interface showing a card project screen 700 organized by recipient. Card project screen 700 may be selected from menu bar 109. In one embodiment, the different versions of the card can be shown along with their association to an individual or group. In this example, card 702 can be associated with a first member and card 704 can be associated with a second member. In another embodiment, cards in this screen can be associated with two or more member groups.

The data for the card designs related to the member list can be collected together in a file. In one embodiment, association information linking card designs and member information such as addresses and member group associations can be included in the file. In yet another embodiment, the file can be used to print cards and related envelopes.

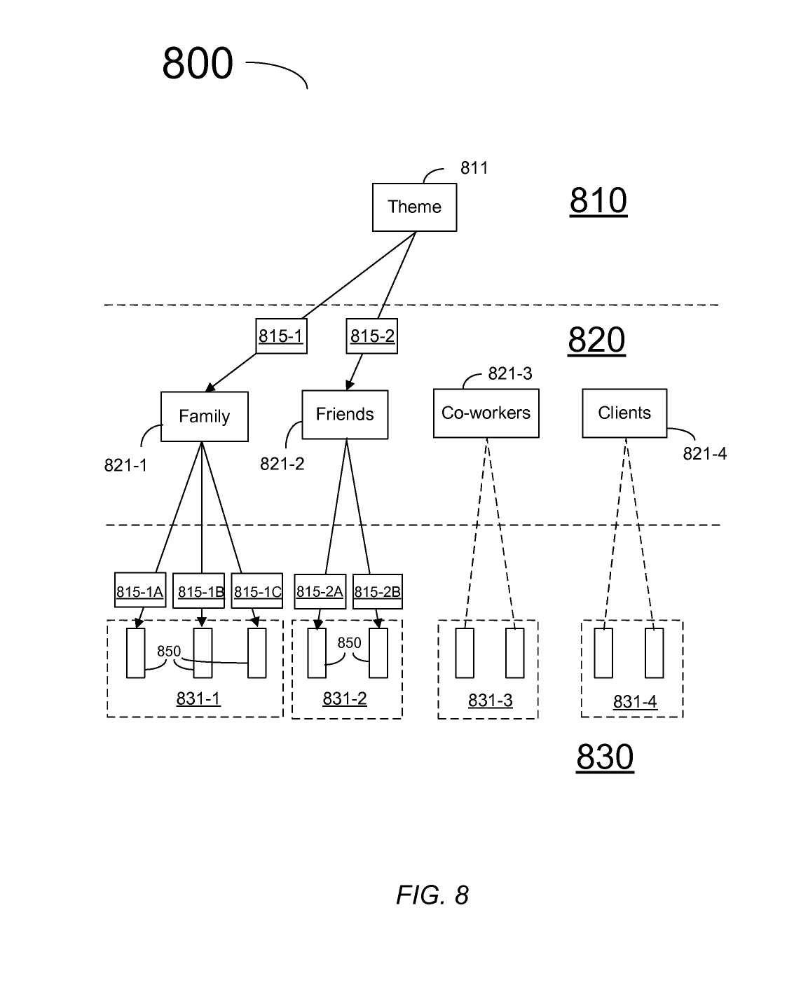

FIG. 8 is a block diagram illustrating layers in a card project 800, according to some embodiments. A theme layer 810 includes a theme 811, which may be a topic for card project 800, such as ‘Holidays Greetings,’ ‘Summer Vacation,’ Kids,‘Wedding,’ work-related topics, or business related topics. For example, theme 811 may be selected from icon 104 in theme indicator 106 (cf. FIG. 1). A group layer 820 includes groups of recipients in a member list, such as ‘Family’ group 821-1, ‘Friends’ group 821-2, ‘Co-workers’ group 821-3, and ‘Clients’ group 821-4. Groups 821-1, 821-2, 821-3, and 821-4 are collectively referred hereinafter as groups 821. Accordingly, once a user selects a theme 811 for card project 800, the user may select groups 821-1 and 821-2 as recipients for the cards. Thus, the user prepares customized cards 815-1 and 815-2, collectively referred hereinafter to as cards 815. Cards 815-1 and 815-2 share common theme 811, and may share certain features, such as an image, a background, a caption in an outside portion of a card. Likewise, cards 815-1 and 815-2 may share certain features in the inside portion of a card, such as a greetings message, a map, a personal signature, or the entire inside portion. In some embodiments, cards 821-1 and 821-2 may be identical when the user decides to send the exact same card to groups 821-1 and 821-2.

A recipient layer 830 includes recipients 850 listed in a members list (cf. FIG. 4). Recipients 850 are grouped according to member groups 831-1, 831-2, 831-3, and 831-4, collectively referred to hereinafter as member groups 831. Each member group 831 is associated with a group 821. In FIG. 8, recipient layer 830 includes ‘Family member’ group 831-1, ‘Friends member’ group 831-2, ‘Co-workers member’ group 831-3, and ‘Clients member’ group 831-4. Member groups 831 may be modified, as recipients 850 may be added, deleted, or transferred from one member group 831 to another. Member groups 831 may also be populated as new groups 821 are created by the user. Accordingly, the user may desire to customize cards 815 even further, within a group 821. For example, the user may desire to further customize ‘Family’ card 815-1 for each or at least one of the recipients 850 in ‘Family members’ group 831. Thus, the user may create customized cards 815-1A, 815-1B, and 815-1C. For example, customized card 815-1A may be edited for ‘Mom and Dad’, customized card 815-1B may be edited for ‘Brother and Sister’, and customized card 815-1C may be edited for ‘Uncle Tom’. Likewise, the user may desire to further customize friend's card 815-2 into cards 815-2A and 815-2B, destined to different members 850 in ‘Friends member’ group 831-2. For example, card 815-2A may include a first map in the inside portion for friends living in a first geographic area. And card 815-2B may include a second map in the inside portion for friends living in a second geographic area.

Accordingly, card project 800 forms a ‘tree’ diagram with layers 810, 820, and 830, such that at each layer card 815 may be customized according to groups 820 and member groups 830. As a result, customized cards 815-1A, 815-1B, and 815-1C may share a first group of features, and customized cards 815-2A and 815-2B may share a second group of features. Accordingly, the first group of features and the second group of features may have common elements, stemming from theme 811 in layer 810. The features shared between customized cards 815-1A, 815-1B, 815-1C, 815-2A, and 815-2B may be features in the outside portion or the inside portion of the card.

Although described in terms of card project 800, a project as described in FIG. 8 can be used to design and manage other objects such as books, calendars, posters, photo albums or other printable media. In some embodiments, a printable media may include a coffee cup, a T-shirt, or any other media where a printed pattern may be displayed. For example, instead of customizing a card, one or more calendars can be designed for different family members 850 in ‘Family member’ group 831-1. A calendar project may display photos with messages for different dates through the year. Photos and messages can be inserted on different dates to represent birthdays, due dates, conferences, and other events. Moreover, each recipient 850 of a member group 831 can have a different version of the same calendar. For example, a family calendar 815-1 may include pictures of ‘family members’ group 831-1 placed on the respective birthdays. And a friend's calendar 815-2 may include pictures of ‘friends group’ members in the respective birthdays.

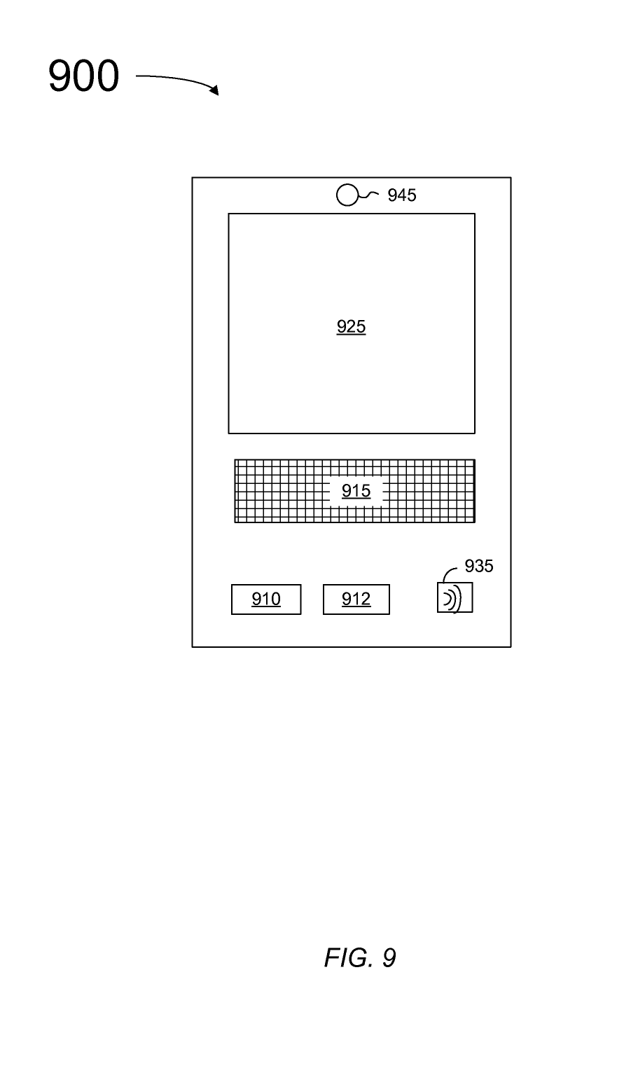

FIG. 9 is a diagram of an electronic device 900 used to create a printer ready document for distribution in a member list, according to embodiments disclosed herein. The printer ready document may be a card, a calendar, a book, a poster, or other printable media as described above (e.g., cards 815, cf. FIG. 8). Electronic device 900 includes a memory circuit 910 configured to store commands, and a user interface 915. User interface 915 may be a keyboard, or a touch screen display to allow a user to enter commands and selections into electronic device 900. Electronic device 900 also includes a processor circuit 912 configured to execute the commands stored in memory circuit 910 and commands provided by a user via user interface 915. Accordingly, processor circuit 912 is configured to create the printer ready document associated to a member list stored in memory circuit 910 (cf. FIG. 4). The member list may include recipients separated into member groups. In some embodiments, processor circuit 912 is configured to form a plurality of member groups in the member list according to commands provided by the user, and store the plurality of groups in memory circuit 910 (e.g., member groups 831, cf. FIG. 8). In some embodiments, processor circuit 912 may be configured to provide common features to the printer ready document according to the member groups formed from the members list. Processor circuit 912 may also be configured to provide common features to the printer ready document according to a theme (e.g., theme 811, cf. FIG. 8). Processor circuit 912 may be configured to create a theme list comprising a plurality of themes, and store the theme list in memory circuit 910.

Electronic device 900 also includes a display 925 configured to show an editable version of the printer ready document according to a user command received via user interface 915. Display 925 is configured to show a plurality of editable versions of the printer ready document according to the plurality of member groups e.g., card project screen 700, cf. FIG. 7). Display 925 may also be configured to show a tree diagram including a theme layer, a group layer, and a recipient layer (e.g., card project 800, theme layer 810, group layer 820, and recipient layer 830, cf. FIG. 8). Accordingly, the three diagram associated with the printer ready document according to the theme (e.g., theme 811, cf. FIG. 8).

In some embodiments, electronic device 900 includes a radio-frequency (RF) antenna 935 coupled to processor circuit 912. RF antenna 935 may be configured to interchange data portions with a network. The network interchanging data with electronic device 900 may be a wireless network, according to some embodiments. For example, a first data portion may include an image to be placed by the processor circuit in the printer ready document. Electronic device 900 may also include a camera 945 configured to capture an image to be included by processor circuit 912 in the printer ready document.

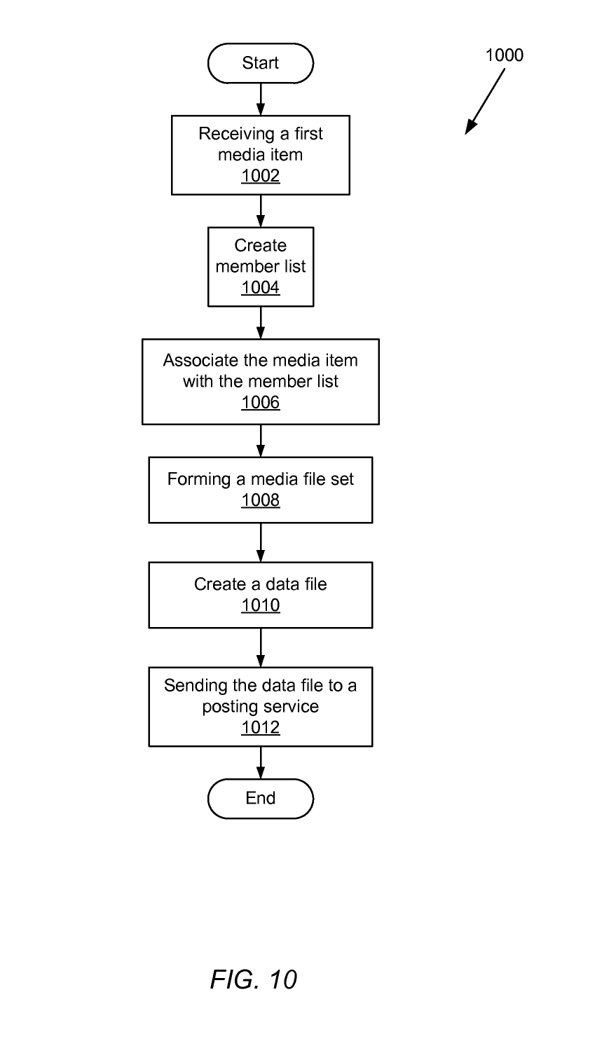

FIG. 10 is a flow chart of steps in a method 1000 for creating and posting cards to list members. The cards in methods 1000 may be an example of any other personalized media item, according to embodiments of the present disclosure. Method 1000 can begin in step 1002 where a first media item is received. In one embodiment, the media item is a card design. A card design in step 1002 may be a card template (e.g., card template 108, cf. FIG. 1). In one embodiment, the card can be designed from a template and pictures for the card can be selected and inserted into the card design. Step 1002 may include collecting an image with a handheld electronic device. In some embodiments, step 1002 may include collecting an image using a camera in the electronic device used to perform method 1000. For example, the user may perform step 1002 with a camera in a cell phone or other handheld electronic device. Step 1002 may also include searching a network for an image, and downloading the image from the network. In some embodiments, step 1002 may include copying and pasting an image from another application running in the electronic device.

In step 1004, a member list can be created. The member list can include member attributes such as member name and address. In another embodiment, the member list can include at least one group. In another embodiment, the member list can be divided into two or more groups. In step 1006, the media item can be associated with the member list. In step 1008, a media file set can be formed using information associated with the first group to personalize the media item. In step 1010, a data file can be created in accordance with the personalized media item data set. The data file may be in a printable format, such as a Portable Document Format (PDF), Tag Image File Format (TIFF), Graphic Interchange Format (GIF), Joint Photographic Experts Group (JPEG) format, PostScript, or any other type of printable digital format known in the art. For example, a PDF file may be in a ‘flattened’ format such that any third party with access to the file is able to print the file, and not able to edit the content.

In step 1012, the data file can be sent to a posting service. In one embodiment, the posting service can print, and distribute the media item. Accordingly, in some embodiments the posting service is a third party vendor that receives the card format including envelope and card. The posting service prints the physical cards in a pre-selected format including shape, size, and material, and places the cards in a mail distribution system. In some embodiments, the shape and size of the cards may be fixed by the user performing method 1000.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An electronic device comprising:
a memory circuit configured to store a plurality of commands;
a user interface; and
a processor circuit configured to execute the plurality of commands stored in the memory circuit and a user command provided by a user via the user interface; wherein
the processor circuit is configured to create a printer ready document associated to a member list stored in the memory circuit;
the processor circuit is configured to form a plurality of member groups from the member list according to the user command, and store the plurality of groups in the memory circuit;
the processor circuit is configured to provide common features to the printer ready document according to the member groups formed from the member list;
and the processor circuit is configured to provide a second plurality of common features to the printer ready document according to a theme.

2. The electronic device of claim 1 further comprising a display configured to show an editable version of the printer ready document according to the user command.

3. The electronic device of claim 2 wherein the display is configured to show a plurality of editable versions of the printer ready document according to the plurality of member groups.

4. The electronic device of claim 2 wherein the display is configured to show a tree diagram including a theme layer, a group layer, and a recipient layer; the tree diagram associated with the printer ready document according to the theme.

5. The electronic device of claim 1 wherein the processor circuit is configured to create a theme list comprising a plurality of themes; and
the processor circuit is configured to store the theme list in the memory circuit.

6. The electronic device of claim 1 further comprising a radio-frequency (RF) antenna coupled to the processor circuit, the RF antenna configured to interchange data portions with a network; wherein
a first data portion comprises an image to be placed by the processor circuit in the printer ready document.

7. The electronic device of claim 1 further comprising a camera configured to capture an image to be included by the processor circuit in the printer ready document.

8. A method for creating and posting a customized personal media item for at least one member of a list of members comprising:
receiving a selection for a personal media item template at a computing device, wherein the personalized media item template provides an initial personalized media item design;
accessing a member list, wherein the member list includes at least a first group;
associating the personalized media item template with the member list;
forming a first personalized media item data set using information associated with the first group;
creating a first data file in accordance with the first personalized media item data set; and
sending the first data file to a posting service, wherein the posting service uses the first data file to form a first customized personalized media item, the first personalized media time configured for delivery to a member of the first group.

9. The method as recited in claim 8 the member list further comprising a second group, the second group not overlapping the first group.

10. The method as recited in claim 9 further comprising:
forming a second personalized media item data set using information associated with the second group to personalize the personalized media item template;
creating a second data file in accordance with a second personalized media item data set; and
sending the second personalized media item data set to the posting service, wherein the posting service configures the second personalized media item data set into a second customized personalized media item, and causes the second customized personalized media item to be delivered to a member of the second group.

11. The method as recited in claim 10 wherein the first customized personalized media item and the second customized personalized media item are different.

12. The method as recited in claim 8 wherein the personalized media item is selected from a group that includes at least, a card, a calendar, a book, a photo album, and a coffee cup.

13. The method as recited in claim 8 wherein the computing device is a portable computing device that is selected from a group that includes at least a cell phone, a portable media player, and a tablet computer.

14. The method as recited in claim 8, wherein the computing device is a desktop computer.

15. The method as recited in claim 10 wherein the sending is carried out over a wireless network.

16. A non-transitory computer readable medium storing commands that when executed by a processor circuit cause a computing device to perform a method, the method comprising:
receiving a selection for a personal media item template at the computing device, wherein the personalized media item template provides an initial personalized media item design;
accessing a member list, wherein the member list includes at least a first group;
associating the personalized media item template with the member list;
forming a first personalized media item data set using information associated with the first group;
creating a first data file in accordance with the first personalized media item data set; and
sending the first data file to an external posting service, wherein the external posting service uses the first data file to form a first customized personalized media item, the first personalized media time configured for delivery to a member of the first group.

17. The computer readable medium as recited in claim 16 the member list further comprising a second group, the second group not overlapping the first group.

18. The computer readable medium as recited in claim 17 further comprising:
forming a second personalized media item data set using information associated with the second group to personalize the personalized media item template;
creating a second data file in accordance with a second personalized media item data set; and
sending the second personalized media item data set to the external posting service, wherein the external posting service configures the second personalized media item data set into a second customized personalized media item, and causes the second customized personalized media item to be delivered to a member of the second group.

19. The computer readable medium as recited in claim 18 wherein the first customized personalized media item and the second customized personalized media item are different.

20. The computer readable medium as recited in claim 16 wherein the personalized media item is selected from a group that includes at least, a card, a calendar, a book, a photo album, and a coffee cup.
